(19) United States
(12) Patent Application Publication
(10) Pub. No.: US 2013/0135981 A1
(43) Pub. Date: May 30, 2013

(54) METHOD FOR REMOTE TRANSMISSION OF AN ENERGY INFORMATION SIGNAL FROM ANIMATE INANIMATE OBJECTS, AND AN ENERGY INFORMATION SIGNAL CONVERTER

(71) Applicants: Evgeny Pavlovich GERMANOV, Moscow (RU); Mikhail Vladimirovich KUTUSHOV, Moscow (RU); Mark GRINDSHTEIN, Natania (IL); Mikhail SHRAYBMAN, Herzlia (IL)

(72) Inventors: Evgeny Pavlovich GERMANOV, Moscow (RU); Mikhail Vladimirovich KUTUSHOV, Moscow (RU); Mark GRINDSHTEIN, Natania (IL); Mikhail SHRAYBMAN, Herzlia (IL)

(21) Appl. No.: 13/505,269

(22) Filed: Apr. 30, 2012

(30) Foreign Application Priority Data
May 26, 2011 (WO) WO2011/062518

(51) Int. Cl. G11B 31/00

(52) U.S. Cl. CPC G11B 31/00
USPC 369/110.01; 369/100

(57) ABSTRACT

A method comprised of transferring energy information signals onto a first intermediate carrier, with subsequent transmission of information to a receiver input and taking off the signal at the reception side of the receiver by transferring the signal onto a second intermediate carrier, for use in any area of the economy. For remote transmission of an energy information signal from animate and inanimate objects, the energy information signal of an original object is converted to an information-wave beam and brought to a coherent state by passing the beam through a crystal located between two polarizers. The converted signal is recorded onto the first intermediate carrier, entered into a transceiver and transmitted over wire and wireless communication networks together with an electromagnetic wave signal, with subsequent recording of the received signal onto the second carrier and reading off the second carrier the energy information signal peculiar to the original object.

### CROSS-REFERENCE TO RELATED APPLICATION

This application is a national stage application that claims the benefit of PCT application no. PCT/RU2009/000590 filed on Oct. 29, 2009 and published on May 5, 2011 under publication no. WO2011/053180. The earliest priority date claimed is Oct. 29, 2009.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to applications of a new physical phenomenon. In particular, it is a method for remote transmission of an energy information signal from animate and inanimate objects, and an energy information signal converter The invention can be used in any technical field, particularly, medicine and medical technology, pharmaceuticals, the food and chemical industries, and ecology. The invention can be realized individually and/or in conjunction with VRT (vegetative resonance testing) and/or in conjunction with [symbol] no BRT (bioresonance therapy).

Currently, one uses only electromagnetic waves for long-range information transmission (acoustic waves are only good for short-range distances), such as VHF (meter), UHF (decimeter) and GHz wavebands. The most frequently used frequency bans are: 130-174 MHz, 350-450 MHz, 850-950 MHz and 1100-1300 MHz. Different methods and devices are currently used for information transmission. Since the very early stages, digital approaches (for instance, Baudot codes) were used for data transmission. It is clear that when information is directly meant for a person, it must be converted properly. In the first place, this pertains to voice and image transmission. As a rule, modulated signals are sent via communication channels. A carrier frequency of transmission, for instance, when broadcasting over a radio channel, is several orders of magnitude higher than a voice signal frequency. Modulation makes it possible to solve the problem of matching frequencies. But one should note that modulation is not limited to use in radio channels. Modern digital methods for transmitting information are also inconceivable without the use of modulation.

Claude Shannon, an American engineer and mathematician, had studied the dependence of bandwidth capacity of a channel with a certain bandwidth on the signal-to-noise ratio. It follows from the Shannon's theorem that, at a zero noise level, it is possible to have an arbitrarily high transmission speed at an arbitrarily low channel bandwidth. Such a prospect would hardly make telephone subscribers happy. But in the absence of noise, even within a one-volt limit, one can imagine any number of signal levels. Shannon's theorem actually makes it clear how noise level limits the maximum value of V at a specified maximum signal amplitude. Standard wire lines have attenuation of 6 dB/km at 800 Hz or 10 dB/km at 1600 Hz. Since the very start of telephony development, wire systems and equipment were designed based on the capacity of the human ear and voice box. Because of this, all traditional telephony systems have had a 3-3.5 kHz bandwidth. There is a relation between attenuation and frequency of the transmitted signal; for a 0.5 mm diameter copper line, it is possible to increase the channel bandwidth due to broadband and a high signal-to-noise ratio. There are numerous noise sources, thermal noise being among the main ones (N=κTB, where T is Kelvin temperature, B is the receiver bandwidth, and κ is Boltzmann's constant). In practice, various pickups have a much stronger effect. Bandwidth increase is achieved by reducing cable length (the distance between network nodes), changing the cable type, for instance, replacing a cable with a larger cross-section cable, or by using a fiber-optic cable. Copper wires will soon likely be replaced by fiber-optic waveguides. A certain effect can also be achieved using an updated noise suppression system (a new and more efficient modem). Usually, two cases of crosstalk are considered:
The signal source and the receiver are on the same side of the cable (NEXT—near end crosstalk);
The signal source and the receiver are on opposite sides of the cable (FRXT—far end crosstalk).

All these problems need a technical solution. A lot has been done already, but other problems arise. Modern superfast communication systems generate new problems and new solutions. What seems superfast today (for instance, 6.4 GB/s) will be ordinary in a few years—just recall the status of Internet trunk channels ten years ago, when 2 MB/s was considered a fantastic speed. (By 2006, RAN network reference channels in Moscow achieved a speed of 10 GB/s). We have practically approached the theoretical limit of the upper transmission speed determined by dielectric polarization time (10⁻¹³ s−10 THz). Recent progress in increasing channel bandwidth is related in large extent to the development of digital data transmission technology. Here, it is necessary to solve problems of synchronization, efficient coding and reliable transmission. The wider the pulse, the more energy it carries, and the better the signal-to-noise ratio, but the lower the limiting transmission speed. Before for each bit, there was a corresponding pulse, or a code sequence swing. Nowadays, a swing only happens when a sequence of zeros changes to a sequence of units or vice versa. The digital method has a number of advantages over analog: high reliability. If noise is lower than the input threshold, its effect is not felt, and it is possible to send the code again.
No dependence on the information source (sound, image or digital data).
The possibility of coding, which increases transmission security.
Time independence. One can transmit not when information has been generated but when a channel is ready.

To increase transmission speed, there is a double-level compression system wherein group coding (RLE) is used at the first level and adaptive prefix coding is used at the second level. In known solutions, information is processed in two stages: first, information is processed using group coding, then the resulting code sequence is “post-squeezed” using prefix coding.

Numerous studies have shown that the main information carrier, whether within a biological object or between individual biological objects, including between people, is energy information radiation of subtle physical fields (SPF). The very information transmission process is an energy, space and time process. Studies have demonstrated that the external macrocosm space-time structure has been transformed, via a continuously recurrent series of impacts, into a chemical continuum of a molecular microcosm of animate objects and a facilitated transformation of chemical structures into physical ones. Both animate and inanimate matter is comprised of the same elements of the Mendeleev periodic system. When distinguishing between animate and inanimate matter, the nature of the structure is essential, but only if the respective structure has a certain function. The transition from life to death while the existing structure is preserved, but the functions that define life have ceased, is only possible for animate matter. Among common feature of animate matter is the ability to self-reproduce. However, because self-reproduction is impossible without hereditary transmission of information and development programs, the main feature in each living organism is its individual information administrative structure.

This group of inventions is based on the following.

All substances and objects around us, including biological objects, are characterized by the presence of certain very weak radiation. These radiations are information-wave in nature, and they carry information about properties of radiating objects (radiation source). They are classified as subtle physical fields (SPF). A property of SPF energy information radiation is the ability to change its phase, up to inversion, when passing through an optical path. Unlike EMP where such effect can only be observed in the optical part of the spectrum, for SPF the property of changing its phase does not depend on their frequency parameters. Herein, the similarity between polarized light and SPF source radiation is that energy information radiations are also linearly polarized vibrations, and, in both cases, the presence of linear polarization can be detected using identical analyzers. It has been established that a feature of SPF is the ability to interact, under certain conditions, with environmental objects, especially with biological objects, for instance, a human body. This interaction is manifested when implementing the process of information-wave transfer of SPF source properties to intermediate or final information carriers. Herein, a wave copy of any one part of an SPF source becomes a carrier of information-wave properties of the entire object. This means that any arbitrarily small part of an SPF carrier will have the same properties as the original source. Therefore, radiation intensity of flat sources or SPF carriers does not depend on the size (area) of the radiating surface. Radiation polarization is the orientation of wave intensity vectors in a plane perpendicular to the light beam. A polarizer (polarizing filter) is a filter that converts non-polarized or partially polarized light to plane-polarized light. Various transmitters are used for transmitting information, and various receivers are used for receiving information. These are well-known telephone sets, TV sets and computers.

The technical object of the group of inventions linked by a single inventive concept is to create an efficient method and device for remote transmission of specific energy information radiation.

The technical result that provides a solution to the claimed object is that it provides efficient transmission of energy information signals over a distance. The technique of transmitting information by energy information radiation and applying it to a remote carrier has been simplified. When used in medicine, the procedure time is shortened, and the functional capabilities for various pathology diagnostics and for determining promising directions for treatment are expanded.

The essence of the invention in terms of the method is that the method for transmission of energy information signals stipulates that these signals are transferred onto a first intermediate carrier, with subsequent transmission of information to the a receiver input, and taking off the signal at the reception side of the receiver by transferring the signal onto the second carrier, for using it in any area of the economy.

In particular embodiments, for remote transmission of an energy information signal from animate and inanimate objects, the energy information signal of an original object is converted to an information-wave beam and brought to a coherent state by passing it through at least one crystal located between two polarizers. The converted signal is recorded onto the first intermediate carrier, entered into a transceiver and transmitted over wire and wireless communication networks (lines) together with an electromagnetic wave signal, with subsequent recording of the received signal onto the second carrier and reading off it the energy information signal peculiar to the original object.

In particular embodiments, the converted signal is recorded onto the first intermediate carrier by modulating/demodulating radiations of standard transceiver equipment by means of an energy information signal.

In particular embodiments, the energy information signal peculiar to the original object is read off the second carrier by means of a biophysical instrument from the BRT or VRT group.

In particular embodiments, a material from the following group is used as the original object: a histological preparation on glass, whole blood, blood plasma or a biologic fluid from the following group: urine, saliva, sperm, a tear, sweat, a skin print and/or a gross specimen piece, or its imprint on any material.

In particular embodiments, to transmit an energy information signal over wire and wireless communication networks (lines), one uses standard transceiver equipment from the following group: a wireless telephone, a computer, and cable communication lines including copper and/or fiberglass communication lines.

In particular embodiments, the energy information signal is transmitted over the Internet.

In particular embodiments, optical disks (CDs) are used as intermediate carriers.

In particular embodiments of the method, energy information of the signal from inanimate objects is transmitted by transferring the signals onto an intermediate carrier, for instance, an optical disk (CD), with subsequent transmission of information to the input of a standard device, for instance, a computer, a wireless telephone, or a telephone communications node and taking off the signal on the reception side by transferring it to the second (final) carrier for further use in any area of the economy.

The essence of the invention in terms of the device is that the converter of the energy information signal comprises at least one crystal located between two polarizers, one of which is located on the side of the source of the energy information signal, and the other one is located on the side of acting on the object by means of the converted signal.

In particular embodiments of the device, at least one crystal is located between two crossed (and/or parallel) polarizers.

In particular embodiments of the device, the converter has a platform for the object that is the source of an ultra weak energy information signal located under one polarizer, and a container for the intermediate carrier located above the other polarizer.

In particular embodiments of the device, the container has a cable for connecting to the circuit of a biophysical instrument from the BRT or VRT group.

In particular embodiments of the device, the converter comprises at least one crystal from the following group: quartz crystals, Iceland spar crystals, and liquid crystals.

In particular embodiments of the device, one polarizer is fixed, and the other one is mounted with the capability of turning and taking a reading of the turn angle up to 90°.

### SUMMARY

The method comprises the steps of transferring energy information signals onto a first intermediate carrier, with subsequent transmission of information to a receiver input and taking off the signal at the reception side of the receiver by transferring the signal onto the second intermediate (final) carrier, for using it in any area of the economy. For remote transmission of an energy information signal from animate and inanimate objects, the energy information signal of an original object is converted to an information-wave beam and brought to a coherent state by passing it through at least one crystal located between two polarizers. The converted signal is recorded onto the first intermediate carrier, entered into a transceiver and transmitted over wire and wireless communication networks (lines) together with an electromagnetic wave signal, with subsequent recording of the received signal onto the second carrier and reading the energy information signal peculiar to the original object off the second carrier. The energy information signal peculiar to the original object is read off the second carrier by means of a biophysical instrument from the BRT or VRT group. The converter comprises a contact, a casing (container) for the object to be acted on by an ultra-weak energy information signal, an upper base, a first stanchion, a film holder, an upper polarization film (polarizer), a quartz plate, quartz holders, a second film holder, a second stanchion, an adjustment dog, a lower polarization film (polarizer), a lower ring of the film holder, a lower base, a third stanchion, shock absorbers, and a platform for the source of the energy information signal. Efficient transmission of energy information signals over a distance has been ensured, and the technique has been simplified. When using the invention in medicine, the procedure time is shortened, and functional capabilities for diagnostics of various pathologies and determining promising directions for treatment are expanded.

### DRAWINGS

FIG. 1 shows an example of the converter embodiment

FIG. 2 shows the general three-dimensional (axonometric) view of the converter.

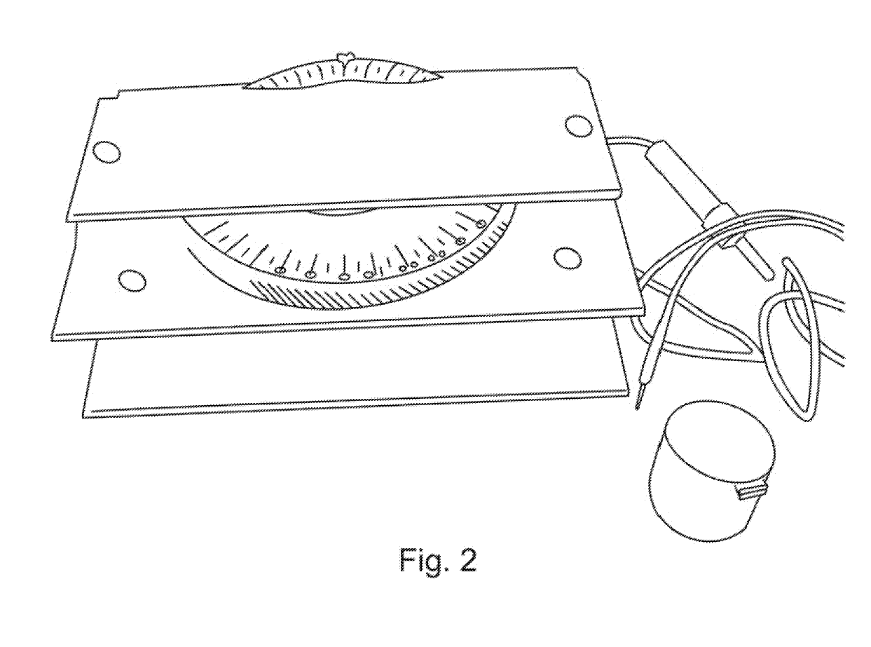

### DETAILED DESCRIPTION

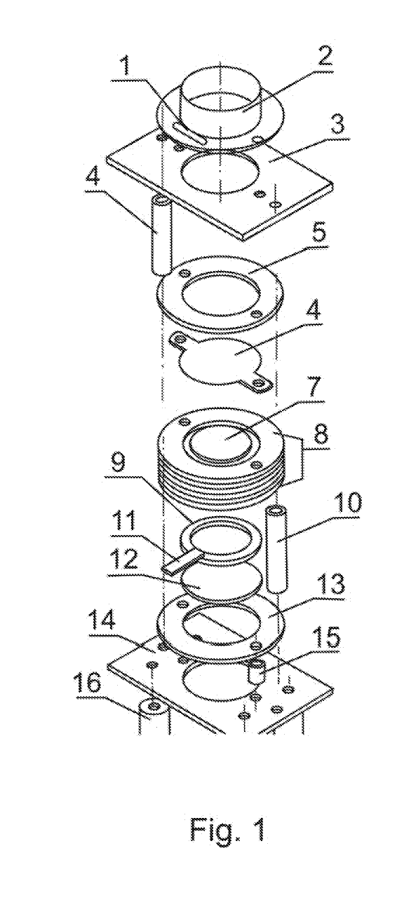

The parts in FIG. 1 are sequentially separated from the bottom up along the signal direction. The converter comprises a contact 1, a casing (container) 2 for the object to be acted on by an ultra-weak energy information signal, an upper base 3, a first stanchion 4, a film holder 5, an upper polarization film (polarizer) 6, a quartz plate 7, quartz holders 8 (6 pieces), a second film holder 9, a second stanchion 10, an adjustment dog 11, a lower polarization film (polarizer) 12, a lower ring 13 of the film holder 12, a lower base 14, a third stanchion 15, shock absorbers 16 (4 pieces), and a platform (not shown) for the source of the energy information signal.

The contact 1 is designed for connecting, by means of a cable, to an instrument for VRT (vegetative resonance testing) when the converter operates with this instrument. A vessel with a substance (homeopathic grits, alcohol, water, etc.) is inserted in the casing 2; amplified and converted (by means of a system of polarizers and crystals) information from the original preparation located in the hole of the lower base 14 on the platform is “recorded” on the substance. The upper base 3 is designed for attaching the casing 2. The upper, middle and lower stanchions 4, 10 and 15 secure the device structure and ensure design clearances between the crystal 7 and the polarizers 6 and 12. The quartz holders 8 (6 pieces) have round holes where the quartz plates 7 are placed; each quartz plate 7 is secured on its individual holder 8. The lower polarization film 12 is secured to the lower holder ring 13 mounted with the capability of turning with the dog 11. The adjustment dog 11 ensures turning of the polarizer 12 until the maximum signal on the contact 1 is achieved. The polarizers 6 and 12 must be parallel to each other and can be located in any plane—from horizontal to vertical. Herein, the lower ring 13 of the film holder (polarizer) 12 is needed for supporting the first (lower) polarizer 12 which is moving along a circle in a horizontal or another plane. In the center of the lower base 14 there is a rounded hole where the platform (cup) with the original substance (preparation)—the source of energy information signal—is placed. The shock absorbers 16 (4 legs) protect from external vibrations and other mechanical effects.

Passing through a lens, crossed polarizers and/or the amplifier-converter crystal, an energy information signal amplifies the information signal coming from animate or inanimate material. The signal coming from both inanimate and animate objects also has the property of focusing (coherence), polarization and amplification. Judging by the results obtained, an information signal can be amplified and brought into coherent state due to focusing through double-convex lenses like regular light in the visible range, as well as through polarizers and crystals where unnecessary background loading information is “clipped”.

The information field taken off a biological object is recorded onto the first carrier using a magnetic inductor or another conventional method. The second carrier is installed on the platform for the polarizer. A signal passes through the converter (the equivalent text term—amplifier), arrives at a take-off device and is transmitted via a cable and DT (drug testing) connector to a device for VRT.

In realizing the method, these energy information signals are transferred onto the first intermediate carrier with subsequent transmission of information signals to the input of a receiver and taking off the signal at the reception side of the receiver by transferring the signal to the second intermediate (final) carrier, for using it in any area of the economy. For remote transmission of an energy information signal from animate and inanimate objects, the energy information signal of the original object is converted to an information-wave beam and brought to a coherent state by passing it through at least one crystal located between two polarizers, the converted signal is recorded onto the first intermediate carrier, entered into a transceiver and transmitted over wire and wireless networks (lines) together with the electromagnetic wave signal to the second carrier, reading off it the energy information signal peculiar to the original object. The converted signal is recorded onto the first intermediate carrier by modulating/demodulating radiations of standard transceiver equipment by means of the energy information signal. The energy information signal peculiar to the original object is read off the second carrier using a biophysical instrument from the BRT or VRT group. A material from the following group is used as the original object: a histological preparation on glass, whole blood, blood plasma or a biologic fluid from the following group: urine, saliva, sperm, a tear, sweat, a skin print and/or a gross specimen piece, or its imprint on any material. To transmit an energy information signal over wire and wireless communication networks (lines) one uses standard transceiver equipment from the following group: a wireless telephone, a computer, and cable communication lines including copper and/or fiberglass communication lines. An energy information signal is transmitted, for instance, over the Internet, and optical disks (CDs) are used as intermediate carriers. Thus, in a preferred embodiment of the method, an energy information signals from inanimate objects are transmitted by transferring these signals onto an intermediate carrier, for instance, an optical disk (CD), with subsequent transmission of information to an input of a standard device, for instance, a computer, a wireless telephone, a telephone communications node and taking off the signal at the reception side by transferring it to the final carrier, for using it in any area of the economy.

Industrial applicability of the claimed method is confirmed by examples wherein diagnostics was realized by taking the information field off a carrier in the form of a biological fluid (urine, κpoB♭, saliva) or off glass slides used for histological analyses, converting the signal and transmitting it remotely onto a device for VRT (thereafter, a “transfer test”). The transfer test results were compared to the results of clinical studies obtained by multifaceted long-term studies of the patient and listed in the medical record. The studies were conducted from August to October, 2009.

### EXAMPLE 1

A man, 58 years old.
Information was read off a biological liquid (urine).
Transfer test results.
Fatty liver. Propensity for hypertension. Increased cholesterol.
Adenomatous prostate hypertrophy.
Lumbar vertebra.
Clinical diagnosis (medical record excerpt):
1. Stroke.
2. Infarct.
3. Gout.
4. Hypertension, 2nd degree.
5. Disculatory hypertension and post-stroke encephalopathy, 2nd degree.
6. Chronic cholelithasis. Calculous cholecystisis in the remission stage.
7. Echo signs of diffuse changes in the liver, chronic urinary diathesis, a cyst in the left kidney.

### EXAMPLE 2

A woman, 54 years old.
Information was read off a biological liquid (urine).
Transfer test results.
Chronic adnexitis. Fallopian tubes. Parametrium. Abdominal and small pelvis adhesions. Myoma. Herpes 2. Psycho-vegetative stress.
Stress load, 5^{th} degree. Endocrine disorders. Uric salts.
Rheumatism in the remission stage. Hemolytic streptococcus. Lumbar vertebra.
Clinical diagnosis (medical record excerpt):
1. Nodular goiter.
2. Metabolism disorder.
3. Gonarthrosis.
4. Chronic cholecystisis. Chronic secondary pancreatitis.
5. Moderate myocardium changes.
6. Excised uterine myoma, endometriosis.
7. Degenerative dystrophic changes lumbosacral spine, Schmorl's nodule, paramedian hernia.
8. Herpes

### EXAMPLE 3

An anonymous patient.
Testing was performed for cancer. Information was read off glass slides.
Transfer test result—presence of cancer. Clinical diagnosis—low-grade differentiated adenocarcinoma.

### EXAMPLE 3

An anonymous patient. Testing was performed for cancer. Information was read off glass slides.
Transfer test result—absence of cancer. Clinical diagnosis—healthy tissue.

### EXAMPLE 4

An anonymous patient. Testing was performed for cancer. Information was read off glass slides.
Transfer test result—absence of cancer. Clinical diagnosis— [symbol] [symbol] .

### EXAMPLE 5

An anonymous patient. Testing was performed for cancer. Information was read off glass slides.
Transfer test result—absence of cancer. Clinical diagnosis— [symbol] [symbol] .

### EXAMPLE 6

An anonymous patient. Testing was performed for cancer. Information was read off glass slides.
Transfer test result—presence of cancer. Clinical diagnosis—connective tissue.

### EXAMPLE 7

An anonymous patient. Testing was performed for cancer. Information was read off glass slides.
Transfer test result—presence of cancer. Clinical diagnosis—ovarian carcinoma.

### EXAMPLE 8

An anonymous patient. Testing was performed for cancer. Information was read off glass slides.
Transfer test result—presence of cancer. Clinical diagnosis—renal carcinoma.

### EXAMPLE 9

An anonymous patient. Testing was performed for cancer. Information was read off glass slides.
Transfer test result—presence of cancer. Clinical diagnosis—low-grade differentiated adenocarcinoma.

### EXAMPLE 10

An anonymous patient. Testing was performed for cancer. Information was read off glass slides.
Transfer test result—presence of cancer. Clinical diagnosis—liver carcinoma.

### EXAMPLE 11

An anonymous patient. Testing was performed for cancer. Information was read off glass slides.
Transfer test result—presence of cancer. Clinical diagnosis—renal carcinoma.

### EXAMPLE 12

A woman, 58 years old. Testing was performed for cancer.
Information was read off a biological liquid (urine).
Transfer test result—absence of cancer. Clinical diagnosis—absence of cancer.

### EXAMPLE 13

A woman, 54 years old. Testing was performed for cancer.
Information was read off a biological liquid (urine).
Transfer test result—absence of cancer. Clinical diagnosis—absence of cancer.

### EXAMPLE 14

A woman, 64 years old. Testing was performed for cancer.
Information was read off a biological liquid (urine).
Transfer test result—absence of cancer. Clinical diagnosis—absence of cancer.

### EXAMPLE 15

A man, 54 years old. Testing was performed for cancer. Information was read off a biological liquid (urine).
Transfer test result—presence of cancer. Clinical diagnosis—presence of cancer.

### EXAMPLE 16

A man, 54 years old. Testing was performed for cancer.
Information was read off a biological liquid (urine).
Transfer test result—absence of cancer. Clinical diagnosis—presence of cancer.

### EXAMPLE 17

A woman, 76 years old. Testing was performed for gastric ulcer.
Information was read off a biological liquid (urine).
Transfer test result—absence of gastric ulcer. Clinical diagnosis—absence of gastric ulcer.

### EXAMPLE 18

A woman, 23 years old. Testing was performed for gastric ulcer.
Information was read off a biological liquid (urine).
Transfer test result—presence of gastric ulcer. Clinical diagnosis—presence of gastric ulcer.

### EXAMPLE 19

A woman, 24 years old. Testing was performed for gastric ulcer.
Information was read off a biological liquid (urine).
Transfer test result—absence of gastric ulcer. Clinical diagnosis—presence of gastric ulcer.

### EXAMPLE 20

A woman, 50 years old. Testing was performed for gastric ulcer.
Information was read off a biological liquid (urine).
Transfer test result—absence of gastric ulcer. Clinical diagnosis—absence of gastric ulcer.

### EXAMPLE 21

A man, 33 years old. Testing was performed for gastric ulcer.
Information was read off a biological liquid (blood).
Transfer test result -presence of gastric ulcer. Clinical diagnosis—presence of gastric ulcer.

### EXAMPLE 22

A man, 26 years old. Testing was performed for hepatitis. Information was read off a biological liquid (urine).
Transfer test result—presence of hepatitis. Clinical diagnosis—presence of hepatitis.

### EXAMPLE 23

A man, 34 years old. Testing was performed for hepatitis. Information was read off a biological liquid (urine).
Transfer test result—presence of hepatitis. Clinical diagnosis—presence of hepatitis.

### EXAMPLE 24

A woman, 54 years old. Testing was performed for hepatitis. Information was read off a biological liquid (saliva).
Transfer test result—absence of hepatitis. Clinical diagnosis—absence of hepatitis.

### EXAMPLE 25

A woman, 48 years old. Testing was performed for hepatitis. Information was read off a biological liquid (urine).
Transfer test result—presence of hepatitis. Clinical diagnosis—presence of hepatitis.

Thus, the results of the above tests confirm a high accuracy of the diagnostics performed remotely in the shortest possible time. Thereby, the fact of the existence and the possibility of transmission, reception and reading of an energy information signal from the original object has been established and confirmed.

Thus, the efficient method and device for remote transmission of specific energy information radiation have been developed.

[symbol] [symbol] [symbol] [symbol] Herein, efficient transmission of energy information signals over a distance is provided; a technique for transmitting information by energy information radiation and applying it to a remote carrier has been simplified; when used in medicine, the procedure time has been shortened, and the functional capabilities for diagnostics of various pathologies and determining promising directions for treatment are expanded.

What is claimed:

1. A method for transmission of energy information signals that comprising the steps of transferring said signals onto a first intermediate carrier, with subsequent transmission of information to an input of a receiver and taking off a signal at a reception side of a receiver by transferring said signal onto a second carrier, for using said signal in any area of the economy.

2. The method according to claim 1, wherein, for remote transmission of an energy information signal from animate and inanimate objects, the energy information signal of an original object is converted to an information-wave beam and brought to a coherent state by passing the beam through at least one crystal located between two polarizers, the converted signal is recorded onto the first intermediate carrier, entered into a transceiver and transmitted over wire and wireless communication networks together with an electromagnetic wave signal, with subsequent recording of a received signal onto the second carrier and reading off the second carrier the energy information signal peculiar to the original object.

3. The method according to claim 2, wherein the converted signal is recorded onto the first intermediate carrier by modulating and demodulating radiations of standard transceiver equipment by means of an energy information signal.

4. The method according to claim 2, wherein the energy information signal peculiar to the original object is read off the second carrier by means of a biophysical instrument from a BRT or VRT group.

5. The method according to claim 1, wherein the original object is a material selected from the group consisting of: a histological preparation on glass, whole blood, blood plasma and a biologic fluid selected from the group consisting of urine, saliva, sperm, a tear, sweat, a skin print, a gross specimen piece, and a gross specimen's imprint on any material.

6. The method according to claim 1, wherein, to transmit an energy information signal over wire and wireless communication networks, one uses standard transceiver equipment from a wireless telephone, a computer, and cable communication lines including copper, and/or fiberglass communication lines.

7. The method according to claim 1, wherein the energy information signal is transmitted over Internet.

8. The method according to claim 1, wherein optical disks (CDs) are used as intermediate carriers.

9. The method according to claim 1, wherein energy information of the signal from inanimate objects is transmitted by transferring the signals onto an intermediate carrier, for instance, an optical disk or CD, with subsequent transmission of information to the input of a standard device, for instance, a computer, a wireless telephone, or a telephone communications node and taking off the signal on the reception side by transferring the signal to the second carrier for further use in any area of the economy.

10. A converter of an energy information signal comprising at least one crystal located between two polarizers, one polarizer is located on a side of a source of the energy information signal, and the other polarizer is located on another side acting on an object by means of a converted signal.

11. The converter according to claim 10, wherein at least one crystal is located between two crossed and/or parallel polarizers.

12. The converter according to claim 11, wherein the converter has a platform for an object that is the source of an ultra weak energy information signal located under one polarizer, and a container for an intermediate carrier located above the other polarizer.

13. The converter according to claim 12, wherein the container has a cable for connecting to a circuit of a biophysical instrument from a BRT or VRT group.

14. The converter according to claim 10, wherein the converter comprises at least one crystal selected from the group consisting of quartz crystals, Iceland spar crystals, and liquid crystals.

15. The converter according to claim 10, wherein one polarizer is fixed, and the other polarizer is mounted with the ability to turn and take a reading of a turn angle up to 90°.
